(19) United States
(12) Patent Application Publication
(10) Pub. No.: US 2007/0200828 A1
(43) Pub. Date: Aug. 30, 2007

(54) Small form-factor key design for keypads of mobile computing devices

(76) Inventors: Peter Skillman, San Carlos, CA (US); Richard Gioscia, Santa Clara, CA (US)

Correspondence Address: SHEMWELL MAHAMEDI LLP, 4880 STEVENS CREEK BOULEVARD, SUITE 201, SAN JOSE, CA, 95129, US

(21) Appl. No.: 11/364,813

(22) Filed: Feb. 27, 2006

(51) Int. Cl. G09G 5/00

(52) U.S. Cl. 345/169

(57) ABSTRACT

A keypad includes a plurality of multi-portion keys having two or more key-portions within a common footprint. Each key-portion is independently usable with respect to any other key-portion. A plurality of switches are oriented such that insertion of any key-portion will engage a respective switch associated with a particular key-portion.

### TECHNICAL FIELD

The disclosed embodiments relate generally to mobile computing devices. More particularly, embodiments disclosed herein relate to small form factor key designs and keypad implementations for mobile computing devices.

### BACKGROUND

As digital applications increase, the consumer demand for portable digital devices (“mobile computing device”) has resulted in an increasing demand for small form factor key-pads for user input to portable digital devices. A factor limiting the utility and consumer demand for a mobile computing devices is the ability for a user to perform alpha-numeric key selection rapidly, and with a minimum of user error.

### BRIEF DESCRIPTION OF THE DRAWINGS

FIG. 1 depicts a multi-portion key having first and second key-portions within a common footprint, according to an embodiment of the invention.

FIG. 2 depicts a keypad incorporating a plurality of multi-portion keys, under an embodiment of the invention.

FIG. 3A shows a side elevation view of a pivot key or toggle key embodiment of a multi-portion key.

FIG. 3B shows an embodiment of a pivot or toggle key implementation with a first key-portion depressed by a user, as shown under an embodiment of FIG. 3A.

FIG. 3C shows an alternative pivot key embodiment of the multi-portion key with a flat key surface.

FIG. 3D depicts a side elevation view of an embodiment of a multi-portion key with a depressed center surface contour.

FIG. 4A shows a side elevation view of a split-key embodiment of a multi-portion key.

FIG. 4B shows the split-key embodiment of FIG. 4A with a first key-portion depressed by a user.

FIG. 4C shows an alternative split-key embodiment of a multi-portion key with a flat key surface.

FIG. 5A shows a side elevation view of a flex-key embodiment of a multi-portion key.

FIG. 5B shows the flex-key embodiment of FIG. 5A with a first key-portion depressed by a user.

FIG. 5C shows an alternative flex-key embodiment of the multi-portion key with a flat key surface.

FIG. 6 depicts a keypad having multi-portion keys 630 oriented on an angle under an embodiment of an invention.

FIG. 7 depicts a block diagram of select components of a mobile computing device 700 used in conjunction with the embodiments discussed herein.

FIG. 8 depicts an embodiment of a mode select key for use in conjunction with an embodiment of a keypad having a multi-portion keys.

FIG. 9 depicts an alternative embodiment of a mode select key for use in conjunction with a keypad having multi-portion keys.

FIG. 10 depicts an alternative embodiment of a mode select key for use in conjunction with a keypad having multi-portion keys.

FIG. 11 depicts an embodiment of a multi-portion key having first-mode and second mode characters thereon.

FIG. 12 depicts an alternative embodiment of a multi-portion key having first mode and second mode characters thereon.

FIG. 13 illustrates a multi-portion key implemented on a keypad that is configured for use with predictive text or text selection logic, under an embodiment of the invention.

### DETAILED DESCRIPTION

Embodiments of the invention provide a small form-factor keypad that divides the use of individual keys to maximize the space allotted for the keypad.

According to an embodiment of the invention, a keypad includes a plurality of multi-portion keys having two or more key-portions within a common footprint. Each key-portion is independently usable with respect to any other key-portion. One result that can be achieved is that a key footprint can carry and provide multiple key values using independently acuatable portions, such that a single press or actuation event on a footprint can yield two or more values, depending on the positioning or orientation of the press/actuation. In the context of a keyboard, for example, the number of individual key footprints necessary to provide a full keyboard may be significantly reduced by combining multiple (i.e. two or more) key assignments on one footprint. In particular, a quasi-QWERTY layout can be achieved using minimal key footprints.

According to an embodiment, a plurality of switches are oriented such that insertion of any key-portion of a footprint will engage a respective switch associated with the particular key-portion. Thus, multiple switches may be assigned to a single key footprint, and the key structure(s) contained in each footprint may align with individual switches. Such an alignment enables each key structure or key portion to be independently usable of other portions/structures within the same footprint.

In an embodiment, a keypad including a plurality of multi-portion keys is arranged to provide a QWERTY key layout, or a configuration similar to a QWERTY key layout.

Still further, a multi-portion key may include a pivoting design wherein the key is configured to pivot around a pivot member. First and second key-portions may be provided on opposite sides of the pivot member, so that individual key-portions can be actuated independently by depression or movement of an individual key-portion.

According to another embodiment, key-portions of a multi-portion key are formed from separate physical members that share a common footprint. The key-portions are configured to move independently from each other when depressed or moved, thereby independently engaging their respective switches. In an embodiment, a keypad may include keys with alphabetical assignments, with at least some keys having multi-portions. In this way, specific alphabetical characters of a select alphabet can be individually selected by engaging a key-portion. According to an embodiment, alphabetical keys and alphabetical key-portions are arranged according to a known character arrangement, such as a QWERTY key arrangement common to American key layouts, or an alphabetical key arrangement for a particular alphabet.

Key Design

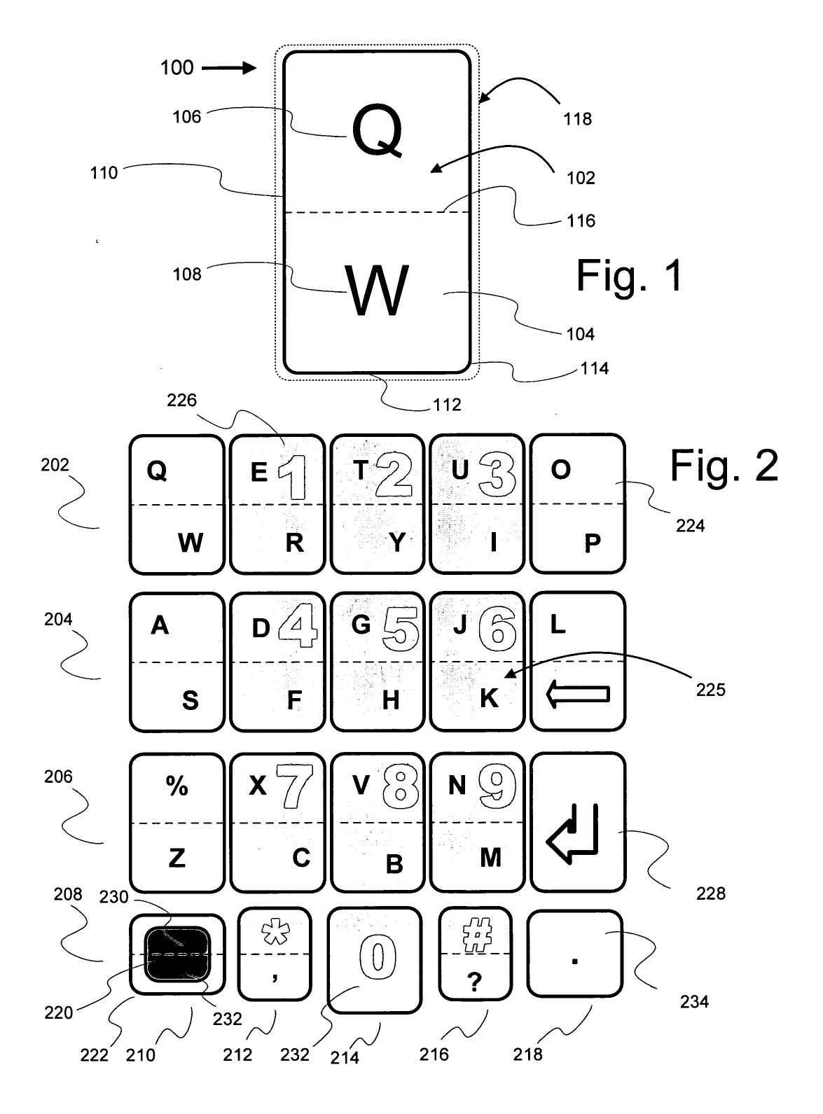

FIG. 1 depicts a multi-portion key having first and second key-portions within a common footprint, according to an embodiment of the invention. A rectangular shaped multi-portion key 100 with rounded corners 114 has elongated sides 110 extending vertically and the shorter sides 112 extending horizontally. Multi-portion key 100 includes first second key-portions 102, 104 within the common footprint 118. In an embodiment, the footprint is coextensive with the outer boundary of the key, as represented by the respective sides 110, 112 and corners 114, but is depicted by the dotted line in FIG. 1 for illustrative clarity. Alternative embodiments comprehend alternative footprint shapes for multi-portion keys, such as square or other polygonal shapes, circles, ovals, ellipses and race-track shapes. Polygonal shaped keys can include sharp cornered embodiments, and rounded cornered embodiments.

Each key-portion 102, 104 within a common footprint 118 is independently actuatable, such that the actuation of one of the key-portions 102, 104 by a user will not actuate the other key-portion. Numerous key structure constructions are contemplated for use within footprint 118, including (i) toggle construction, (ii) split-key construction, and (iii) flex or squish key construction. With regard to toggle key construction, an embodiment may provide a multi-portion key formed from a rigid member configured to pivot around a pivot member, and where the first and second key-portions are on opposing sides of the pivot member. In an embodiment of split-key construction, a multi-portion key comprises physically separate first and second key-portions that are independently movable. In an embodiment of a flex key construction, the multi-portion key may include a deformable region connecting the first and second key-portions. In such a construction, the depression of the first key-portion to the point of making electrical contact may affect the position or attitude of the second key-portion, but will not depress the second key-portion to the point of electrical contact with its respective switch.

A division 116 (represented by a dotted line in FIG. 1) across a key identifies and separates the first and second key-portions 102, 104 of the overall key structure contained within the footprint 118. While an embodiment such as shown in FIG. 1 displays two key portions, the such depiction is only one design implementation, and is not intended to limit the appended claims, which envision various multi-portion key embodiments having two key-portions, three-key-portions, four key-portions, and more than four key-portions within a common footprint.

As mentioned, a keypad comprising a plurality of multi-portion keys 100 saves valuable real-estate on a surface of a mobile computing device, which is inherently limited. Examples of mobile computing devices on which one or more embodiments described herein may be implemented include: (i) cellular telephones, (ii) personal digital assistants, and (iii) multi-function devices capable of cellular telephony, messaging, web browsing, word processing and other functions. In particular, mobile messaging devices which enable users to send emails, text messages (Short Message Service (SMS) or instant messages) or other forms of messaging can provide users with a QWERTY keypad experience.

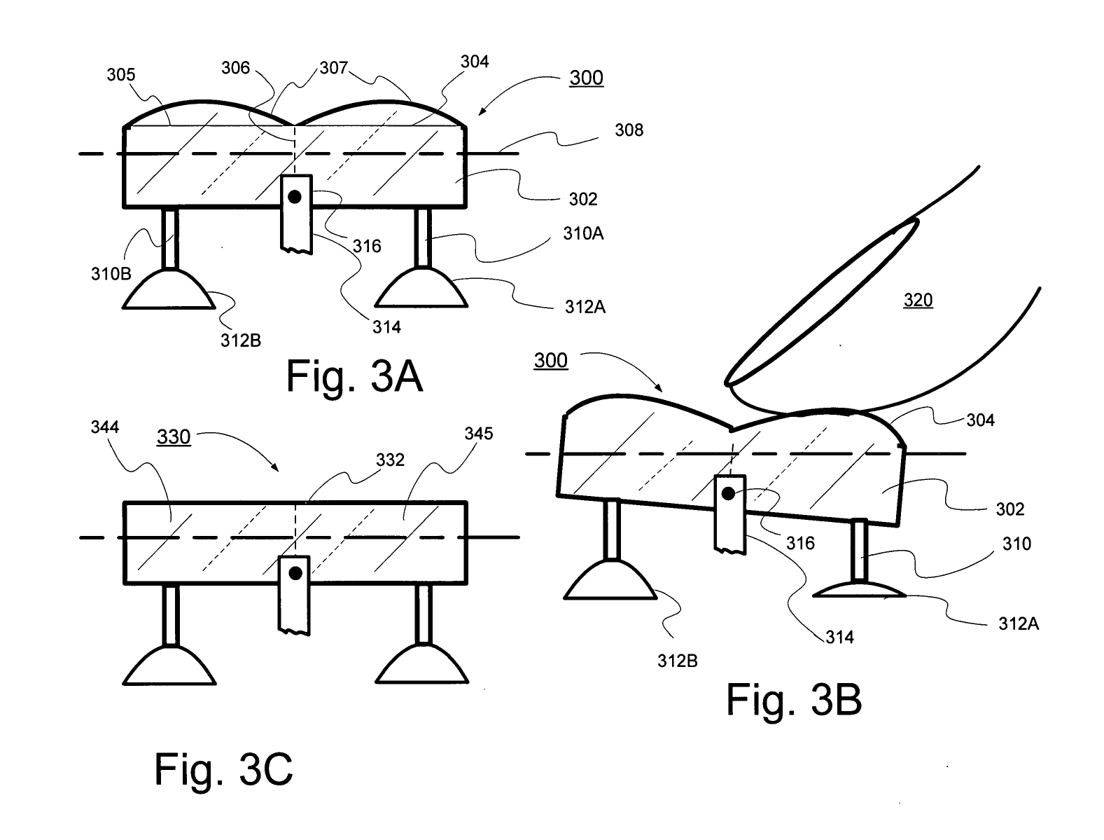

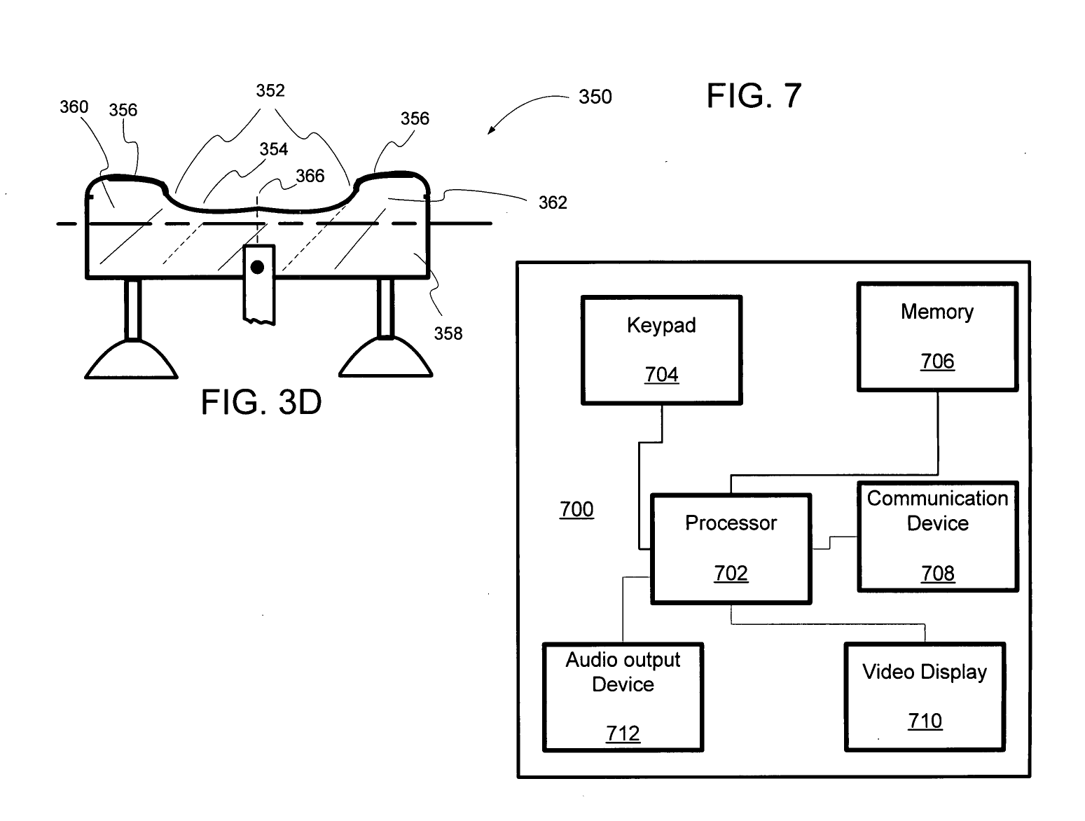

Markings 106, 108 respectively displayed on the surfaces of the first and second key-portions 102, 104 illustrate how such a multi-portion key 100 can function to serve to input multiple character assignments. As such, markings 106, 108 provide feedback as to primary values of the key-portions 102, 104. The depression of the first key-portion 102 actuates a first switch (see FIGS. 3B, 4B and 5B) that initializes a transmission of digital information representing the value of the first marking 106 (e.g. alphabetical character “Q”). Similarly, the depression of the second key-portion 104 actuates a second switch that initializes the transmission of digital information representing the second marking 108 (e.g. alphabetical character “W”).

Keypad

FIG. 2 depicts a keypad 200 with a plurality of multi-portion keys 225, under an embodiment of the invention. In an implementation shown, the component keys are arranged in key matrix having four rows 202-208 and five columns 210-218, although other arrangements and configurations are possible. The multi-portion keys of keypad section 200 are each depicted as having a dotted line delimiting first and second key-portions of that key. Furthermore, in the example provided, specific keys 228 in the third row, and specific keys 222, 232 and 230 in the fourth row, do not display a dotted line separating geometric regions, and therefore do not represent multi-portion keys as described in FIG. 1.

Embodiments of keypads having multi-portions keys can include assignments to two or more of (i) alphabetical values, (ii) numerical values, (iii) special characters (“@” “%”), and/or (iv) mode or commands (“Shift” or “Return”). Keypad 200 illustrates use of all types of such designators, although not all of them are associated with a multi-portion key.

Through the use of multi-portion keys 225, a complete QWERTY or quasi-QWERTY character lay out can be provided. In one configuration, multi-key portions 225 with alphabetical assignments are located in the upper three rows of the four row matrix. As noted elsewhere, a QWERTY arrangement is just one implementation design, and other layouts and arrangements are contemplated.

Given a QWERTY arrangement, alphabetical character assignments are provided on multi-portion keys as follows: (Q & W), (E & R), (T & Y), (U & I), and (O & P). Characters within the same footprint on keypad are described above within the same parenthesis, and the first character within a parenthesis is the character appearing on the upper key-portion, while the second character within a parenthesis is the character appearing on the lower key-portion of its respective key. Similarly, the second and third rows 204, 206 of keypad 200 display alphabetical characters according to the characters displayed in the second and third rows of a QWERTY arrangement. As shown in FIG. 2, the case may be that there are an odd number of keys as in the second and third rows 204, 206, these rows respectively depict characters L and Z as associated with a key that is not associated with any other alphabetical characters. Alternative embodiments are envisioned wherein any alphabetical character within the second row of a QWERTY arrangement can be isolated to maintain a quasi-QWERTY character order in the second row 204.

In mobile computing devices, individual keys are often assigned both alphabetical and numerical values. A mode of the device may determine whether an individual key has an alphabetical or numeric assignment at a given moment. One way to effect a mode between alphabetical or numerical assignment is through use of a mode key, which can be manually operated by the user. In FIG. 2, keypad 200 includes a “mode” key 222. Mode key 222 may be provided with a color or grayscale mode indicator 220. Keys affected by the mode key 222 may be similarly marked or shaded, so that the mode key and those keys operable in a numerical or alternative mode may provide a separate visual effect. One effect is to provide the appearance of a keypad within a keypad. For example, in FIG. 2, the bold white font face of these numbers against the grayscale or color background uniformly identifies the numerals 0-9 as mode-2 characters. A user seeking to input a numeral may first depress the mode key 222, placing the keypad in the alternative (i.e. numerical) mode. If, while the keypad is in the second mode, a key to be depressed has a mode indicator on it, such as key 226, the second mode character “1” displayed on the key or key-portion will be input, rather than one of the first mode characters “E” of “R.”

The dotted horizontal line on mode key 222 indicates first and second key-portions 230, 232 associated therewith. The first key-portion 230 places the keypad into a second mode state until the completion of the next keystroke. While in the second mode state, the depression of any key will restore the keypad to the default “first mode” state. When in the second mode, the depression of any key or key-portion while the keypad is in the second mode will restore the keypad back to a first mode state. Alternatively, the second key-portion 232 of the mode key is a “toggle-on/toggle-off” key. When key-portion 232 is depressed, the keypad is placed into a second mode state, and remains in the second mode state until any portion of mode key 222 is key-portion 232 depressed again, thereby returning the keypad to the “first mode” state. Through use of the toggle-on/toggle-off feature, a string of numeric characters, such as a phone number, can be entered without repeated depression of the mode key 222.

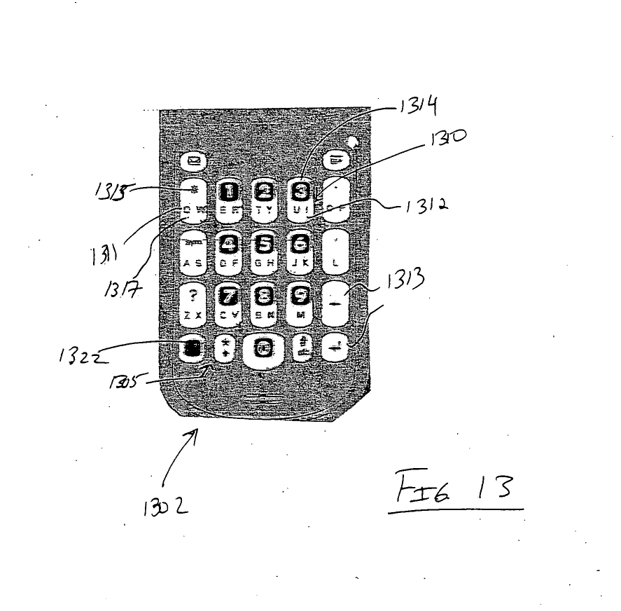

Although the keypad 200 displays no more than one second mode character on any key, as discussed in FIGS. 11 and 12, alternative embodiments of a multi-portion key can include two distinct second mode characters, a first character displayed on the first key-portion, and a second character displayed on the second key-portion.

In addition to mode key 222, and the alphabetical and numeric input keys and key structures described above, keypad 200 displays a variety of other characters, symbols and functions, including second mode characters * and #, and “back-space” and “carriage return” functions. The specific keys displayed throughout this disclosure are offered as an example, and are not intended to limit the appended claims, which comprehend the incorporation of any known key functionality.

Key Structure Design and Implementation

FIG. 3A depicts a side elevation view of a pivot-key (or “toggle key”) embodiment 300 of a multi-portion key. The pivot-key 300 is formed from a contiguous solid structure 302 that includes key-portions 304 and 305 on opposite sides of center line 306. Each key-portion of FIG. 3A has a convex surface region 307. Within FIGS. 3A, 3B and 3C, the dotted line 308 depicts the housing of the keypad. The top portion of the pivot key 300 is disposed above the housing, and the bottom portion of the pivot key is located below the housing line. In an embodiment such as shown, the key structure 302 pivots or toggles about the center line 306. Such a toggle construction may have various forms and designs. For example, a fulcrum component 314 may be disposed beneath the center line 306 between the first and second key-portions 304, 305. The fulcrum member 314 is coupled to the pivot key 300 by a pivot pin 316.

Actuation members 310A and 310B are rigid members that transmit a depressive force from a key-portion to an electrical switching member such as a snap dome 312A, 312B. Actuation member 310A extends from the bottom of key-portion 304 to snap-dome 312A, and actuation member 310B extends from the bottom of key-portion 305 to snap-dome 310B. In an implementation, a contour or convex surface region provides tactile feedback to the fingertip of a user, thereby informing the user of the exact region of the key being engaged. This has the immediate advantage of informing a user as to whether or not the correct key-portion was engaged. When a wrong key-portion is engaged, such tactile feedback is more likely to alert the user of this mistake, allowing the user back-space and re-enter text more quickly than by visual feedback alone. Additionally, tactile feedback helps a user to know the exact position of his fingers to increase the speed and accuracy of engaging subsequent keys or key-portions on the same keypad. In addition to greater speed and accuracy, when the correct key-portion is engaged, the tactile feedback provided by the convex surface regions serves to validate a proper entry, thereby increasing user satisfaction. As a result, the convexity of the individual key-portions can increase both user satisfaction, and the speed and accuracy with which a user is able to engage key-portions when using any of the multi-portion keys described herein.

FIG. 3B shows an embodiment of a pivot or toggle key implementation with a first key-portion depressed by a user, as shown under an embodiment of FIG. 3A. A user finger 320 (or other user-directed object, such as pen tip or stylus) imparts a force against a select key-portion, shown as key-portion 304, causing the toggle action of the key structure 302. The key structure 302 pivots (e.g. about the pivot pin 316), and is supported in a fixed position (e.g. by the fulcrum member 314). In the process, key-portion 304 is depressed, compressing actuation member 310 into snap dome 312A. The snap dome 312A folds in or otherwise deforms under the pressure of the actuation member, completing an electrical connection within the snap dome. During depression of key-portion 304, key-portion 305 pivots upward around the pivot pin 316.

The compressive force against the snap dome 312A is resisted by a restorative force imparted by the snap dome 312A. As a result of this restorative force, when the user's finger 320 is withdrawn from the key, the upward pressure exerted by the snap dome against actuation member 310 functions to restore the pivot key 300 to a level position. A particular advantage of the embodiment of FIGS. 3A and 3B is that the pivot design prevents simultaneous activation of multiple switches corresponding to key-portions within a common footprint. As either of the two key-portions 304, 305 pivot downward, the other key-portion pivots upward and away from it respective snap dome.

FIG. 3C shows an alternative pivot key embodiment 330 of the multi-portion key with a flat key surface 332. The surface of the pivot-key 330 has little or no surface contour to distinguish or separate key-portions 344 and 345. The flat design depicts just one of many possible designs for the interface surface of key structures.

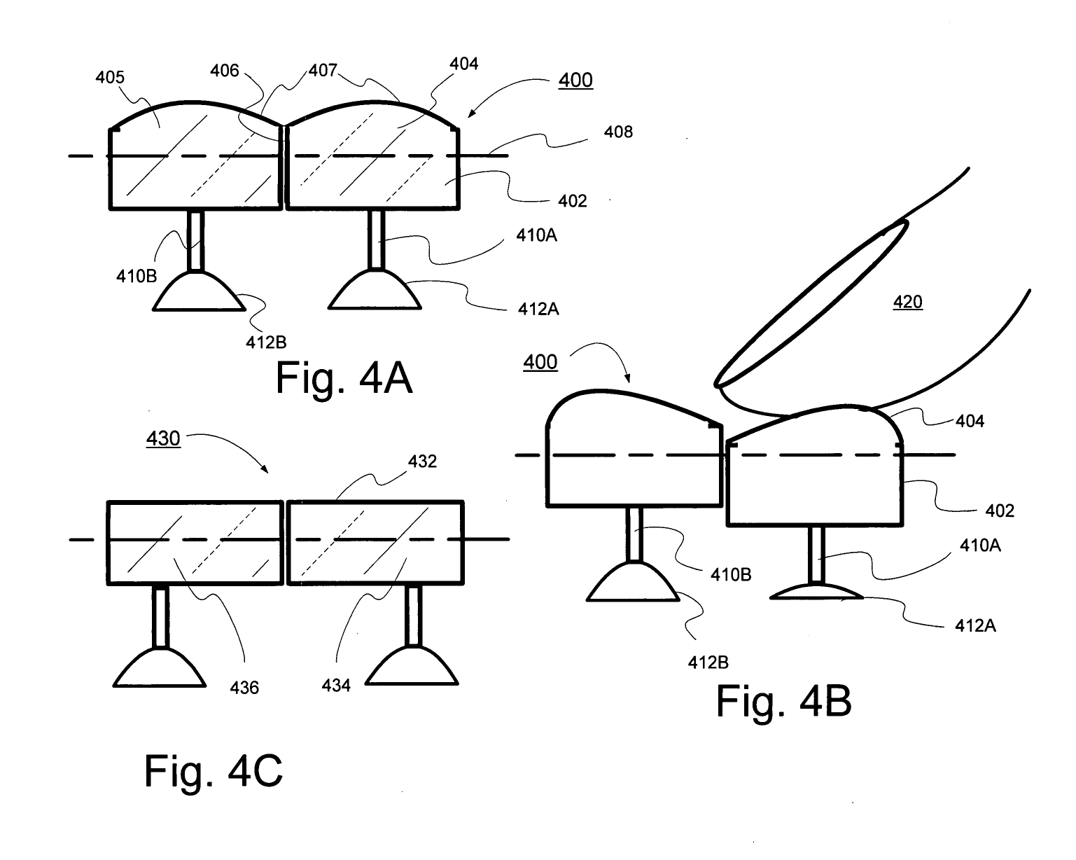

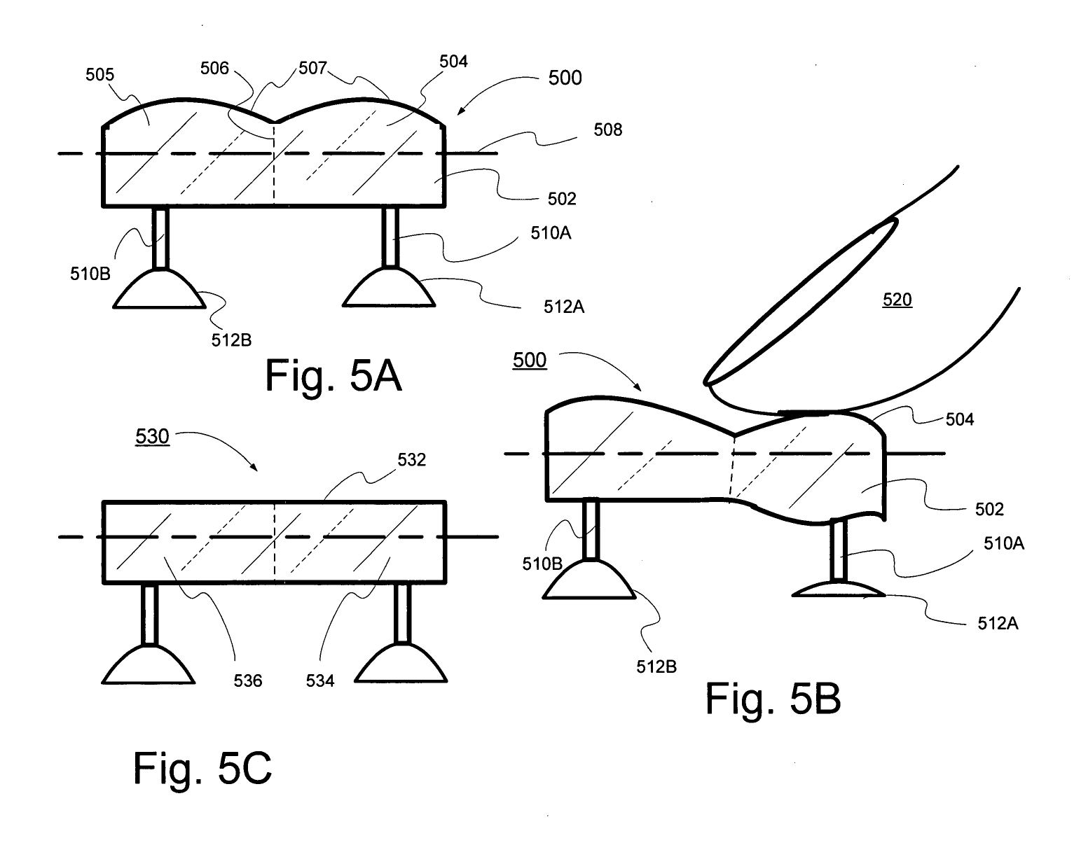

FIG. 3D depicts a side elevation view of an embodiment of a multi-portion key 350 with a depressed center surface contour. Although the multi-portion key of FIG. 3D is described herein in terms of a pivot key embodiment, the depressed center surface contour of FIG. 3D can also be used in conjunction with other multi-portion key structures, including the split-key embodiment of FIG. 4A, and the flex-key embodiment of FIG. 5A. The pivot-key 350 is formed from a contiguous solid structure 358 that includes key-portions 360 and 362 adjoining at center line 366. The surface contour of the key 350 includes a center depression 354 bracketed by raised ends 356 formed on the first and second key portions 360, 362. The surface area between the center depression and each of the raised ends is an upward sloping area 352 that can be curved, as illustrated in FIG. 3D, or substantially straight. In operation, a user will place a thumb, finger or article such as a pencil eraser against the surface of the key, exerting force into the key primarily against the upward sloping area 352. Embodiments envision sloped edges having an upward angle of between about ten and eighty degrees, and more specifically, within the range of about twenty five degrees and sixty degrees, thereby more directly imparting a force of a user's thumb into a component of force that activates the switch component associated with a particular key-portion.

FIG. 4A depicts a side elevation view of a split-key embodiment 400 of a multi-portion key. The split-key 400 is formed from two distinct solid members 404, 405 that form first and second key-portions which are disposed within a common foot print, but which can be moved inward independently of each other. Although the center division 406 between the two key-portions shows slight separation to more clearly illustrate an embodiment having two separate physical members functioning as key-portions, the distance of separation visible in center space 406 is only by way of example. Alternative embodiments are envisioned wherein the facing surfaces of the first and second key-portions are abutting or nearly against each other.

Each key-portion of FIG. 4A has a convex surface region 407. As described above, a convex, or otherwise contoured surface that distinguished the first and second key-portions provides tactile feedback to the fingertip of a user, thereby informing the user of the exact region of the key being engaged. This has a function of informing a user as to whether or not the correct key-portion was engaged. When a wrong key-portion is engaged, the tactile feedback is more likely to alert the user of this mistake, allowing the user back-space and re-enter text more quickly than by visual feedback alone. Additionally, tactile feedback helps a user to know the exact position of his fingers to increase the speed and accuracy of engaging subsequent keys or key-portions on the same keypad. In addition to greater speed and accuracy, when the correct key-portion is engaged, the tactile feedback provided by the convex surface regions serves to validate a proper entry. As a result, the convexity of the individual key-portions can increase usability, including “typing” speed and accuracy with which a user is able to engage key-portions when using any of the multi-portion keys described herein. Within FIG. 4A, FIG. 4B and FIG. 4C, the horizontal dotted line 408 depicts the housing of the keypad. The top portion of the split-key 400 is disposed above the housing, and the bottom portion of the split-key is located below the housing line.

Actuation members 410A and 410B are rigid members that transmit a depressive force from a key-portion to an electrical switching member such as a snap domes 412A, 412B. Actuation member 410A extends from the bottom of key-portion 404 to snap-dome 412A, and actuation member 410B extends from the bottom of key-portion 405 to snap-dome 410B.

FIG. 4B shows the split-key embodiment of FIG. 4A with a first key-portion depressed by a use. A user's finger 420 imparts a force against key-portion 404, depressing key-portion 404 downward. The force is transmitted through key-portion 404, compressing actuation member 410 into snap dome 412A. The snap dome 412A deforms under the pressure of the actuation member, completing an electrical connection within the snap dome. Because the key-portions 404 and 405 are independently movable, during depression of key-portion 304, the position of key-portion 405 remains substantially unchanged. As used herein, the term “substantially” means at least nearly a stated quantity or amount, and at least 80% of a stated quantity or expression.

The compressive force against the snap dome 412A is resisted by a restorative force imparted by the snap dome 412A. As a result of this restorative force, when the user's finger 420 is released, the upward pressure exerted by the snap dome against actuation member 410A will force the actuation member upward, restoring the key-portion 404 to its original position, level with key-portion 405.

FIG. 4C depicts an alternative split-key embodiment 430 of a multi-portion key with a flat key surface 432. The surface 432 has little or no surface contour to distinguish or separate key-portions 434 and 436. The flat design depicts just one of many possible designs for the interface surface of key structures.

FIG. 5A depicts a side elevation view of a flex-key embodiment of a multi-portion key. Flex-key 500 is formed from first and second key-portions 504, 505 that are disposed within a common footprint, and flexibly coupled to form a single flexible key. Because the key-portions 504, 505 are uniformly formed but independently moveable, the center division line 506 between the two key-portions is illustrative of the approximate delineation between the separate key-portions. Flexure can be accommodated by incorporating any of a variety of known materials such as rubber, foam, polymer or other elastomers.

The upper surfaces of key-portions 504, 505 within FIG. 5A each disclose a convex shape 507, the benefits of which are described above. Also as described above, the dotted line 508 within FIG. 5A, FIG. 5B and FIG. 5C, depicts the housing of the keypad. The top portion of the flex-key 500 is disposed above the housing, and the bottom portion of the flex-key is located below the housing line.

Actuation members 510A and 510B are rigid members that transmit a depressive force from a key-portion an electrical switching member such as a snap dome 512A, 512B. Actuation member 510A extends from the bottom of key-portion 504 to snap-dome 512A, and actuation member 510B extends from the bottom of key-portion 505 to snap-dome 510B.

FIG. 5B depicts the flex-key embodiment of FIG. 5A with a first key-portion depressed by a user. A user's finger 520 imparts a force against key-portion 504, depressing or squishing key-portion 504 downward. The force is transmitted through key-portion 504, compressing actuation member 510 into snap dome 512A. The snap dome 512A deforms under the pressure of the actuation member, completing an electrical connection within the snap dome. Because the key-portions 504 and 505 are independently movable, during depression of key-portion 504, the position of key-portion 505 remains substantially unchanged. Concurrent with the depressive force against key-portion 504 is the deformation of adjacent key-portion 505, which is coupled with key-portion 504 to form a contiguous deformable key 500. In addition to the incorporation of flexible material in the key structure, embodiments are envisioned that allow some flexure among the rigid actuation members 510A, 510B, thereby reducing stress on keypad components, and reducing the force necessary to depress a key-portion. Although the depression of one key-portion 504, 505 will cause some deformation of the other key-portion, as shown in FIG. 5B, either key-portion can be actuated without causing actuation of the other key-portion. As used herein, actuation refers to a depression or movement sufficient to engage an electrical switch initiating a digital signal relating to a key or key-portion.

The compressive force against the snap dome 512A is resisted by a restorative force imparted by the snap dome 512A. As a result of this restorative force, when the user's finger 520 is released, the upward pressure exerted by the snap dome against actuation member 510A will force the actuation member upward, restoring the key-portion 504 to its original position, level with key-portion 505. As the key-portion 504 returns to its original position, any flexure imparted to the key 500, the actuation members 510A, 510B, or any other component is abated, as the key structure returns to its original shape.

FIG. 5C depicts an alternative flex key embodiment 530 of a multi-portion key with a flat surface 532. The flat surface has little or no convexity to distinguish or separate key-portions 534 and 536.

Tilted Keypad Arrangements

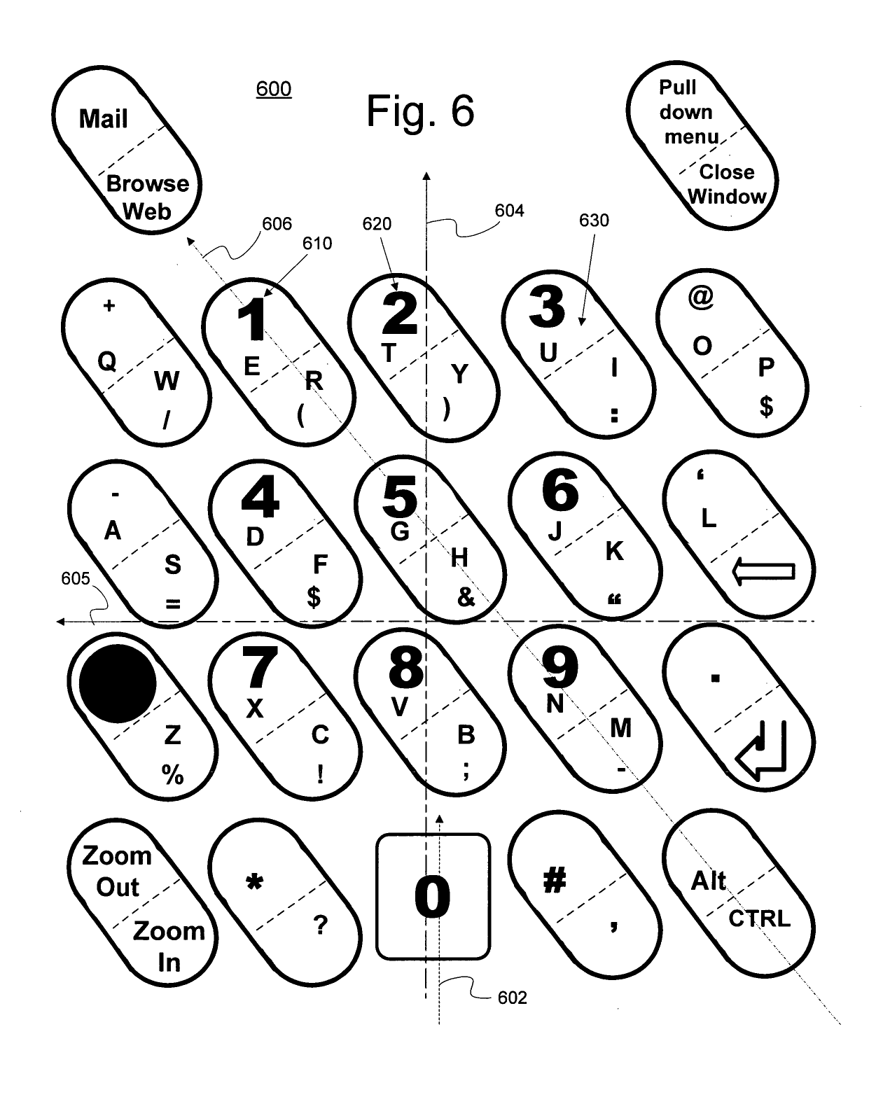

FIG. 6 depicts a keypad having multi-portion keys 630 oriented on an angle under an embodiment of an invention. A vertical axis 604 of the keypad is understood to be aligned with respect to the housing and shape of a mobile computing device supporting the keypad. With respect to this axis, individual keys 630 are tilted (e.g. 45 degrees in either direction). Markings 610, 620 may represent both numbers and characters, and may be tilted or straight with respect to the vertical axis 604, or its corresponding horizontal axis 605. Keys 630 that form the keypad 600 may be formed from a toggle or pivot construction (e.g. FIG. 3A-3C, or FIG. 3D), split-key construction (FIG. 4A-4C) or flex-key implementation (FIG. 5A-5C).

Within keypad 600, multi-portion keys are shown as having a dotted center line that divides the upper key-portion from the lower key-portion. Unless identified by a separate character identifier, keys and key-portions of FIG. 6 are identified herein by a number, letter, or character associated with that key or key-portion. The keypad includes a key matrix having four rows that include keys 1, 4, 7 and * (star), and five columns that include keys Q, E, T, U, and O. The keypad also includes a “mail” key and a “pull-down-menu” key that are not part of the 4×5 matrix. Within the 4×5 matrix, the 0 (zero) key is a rectangular key oriented on an axis 602 parallel to the axis 604 of the keypad. The remaining keys of keypad 600 disclose a racetrack shape, and are oriented on an axis 606 which is about 35 degrees counter-clockwise of the vertical keypad axis 604. The angle of 35 degrees is not intended to limit the various embodiments, which envision key orientations ranging from a zero degree offset to a ninety degree offset from the axis of the keypad.

The 4×5 key matrix includes a quasi-QWERTY arrangement of alphabetical characters. Alphabetical characters in the first row are arranged on multi-portion keys in the order: (Q & W), (E & R), (T & Y), (U & I), and (O & P), where characters within the same footprint on keypad 600 are described above within the same parenthesis, and wherein the first character within a parenthesis is the character appearing on the upper key-portion, and the second character within a parenthesis is the character appearing on the lower key-portion of its respective key. The second and third rows are similarly arranged with appropriate alphabetical characters. Numerical characters are also displayed within the 4×5 matrix. Each numerical character is displayed on the upper key-portion of its respective key. Numerals 1, 2, and 3 are displayed in the second, third, and fourth columns of the first row. Numerals 4, 5, and 6 are displayed in the second, third, and fourth columns of the second row. Numerals 7, 8, and 9 are displayed in the second, third, and fourth columns of the third row. The numeral 0 (zero) is located on a “single-portion” key in the third column of the fourth row.

The mode-shift icon used in FIG. 6 is a darkened circle displayed on the upper key-portion of the “Z” key. The mode selector of FIG. 6 is offered by way of example, and a mode select indicator can be any visual indicator, including, but not limited to, color, hue, a distinguishing shape or style, such as a calligraphic font, or a spatial orientation of a character on its respective key or key-portion. The numerical characters 0 and 1-9 on key pad 600 are depicted in a bold hue, thereby establishing a resemblance to the mode indicator icon. Additionally, numerical characters 1-9 are located on the upper most region of their respective upper key-portions, and the alphabetical characters depicted on the same upper key-portions are oriented lower, to the left, and near the line separating the upper and lower key-portions. By this arrangement, a user will quickly appreciate that, even if a character is not bold face, colored, or in some other way sharing some visible trait with the mode select key, the location of a character on its respective key can identify a character as a first mode key, or a second mode key, according to the pattern established by the numerical keys.

Characters appearing near the center dividing line are first mode characters, and characters appearing at the distal ends of their respective multi-portion keys are second mode characters. In addition to many typographical characters displayed on keypad 600, such as “=” (the equal sign) and “&” (ampersand), keypad 600 includes a variety of functional commands, such as Alt and Control functions, zoom in (enlarge video display) and zoom out (reduce video display) capability, email activation, web browse activation, pull down menu command, close window command, a left arrow for erasing the last character entry, and a “return” key commonly used for line breaks in word processing applications and for selection of options displayed on a screen.

Hardware Diagram

FIG. 7 depicts a block diagram of select components of a mobile computing device 700 used in conjunction with the embodiments discussed herein. The components shown include one or more processors 702, a keypad 704, memory components 706, as well as one or more wireless communication components (such as used for Bluetooth, WiFi, cellular or infrared communications), for both data (text, image, streaming) and voice. Other components include audio output 712 and display 712, which may be contact-sensitive.

As described with other embodiments, the keypad 704 may comprise multi-portion keys, such as provided by any one of toggle, split-key, or flex-key designs described above. Movement or other actuation of such keys results in triggering of input signals to the processor 702, thus enabling a user to operate the keypad 704. The processor 702 may execute applications and use data stored in the memory components 706. The wireless communication device 708, in connection with processor 702 and other components, may enable cellular telephony, text messaging, web browsing, and other wireless activities. The processor may provide display data, such as alphanumeric representation of depressed or actuated keys, to the display 710. Additionally, the processor 702 may chime or provide audio feedback in response to depressed key portions or input using the audio output device 712.

Mode Selection Keys

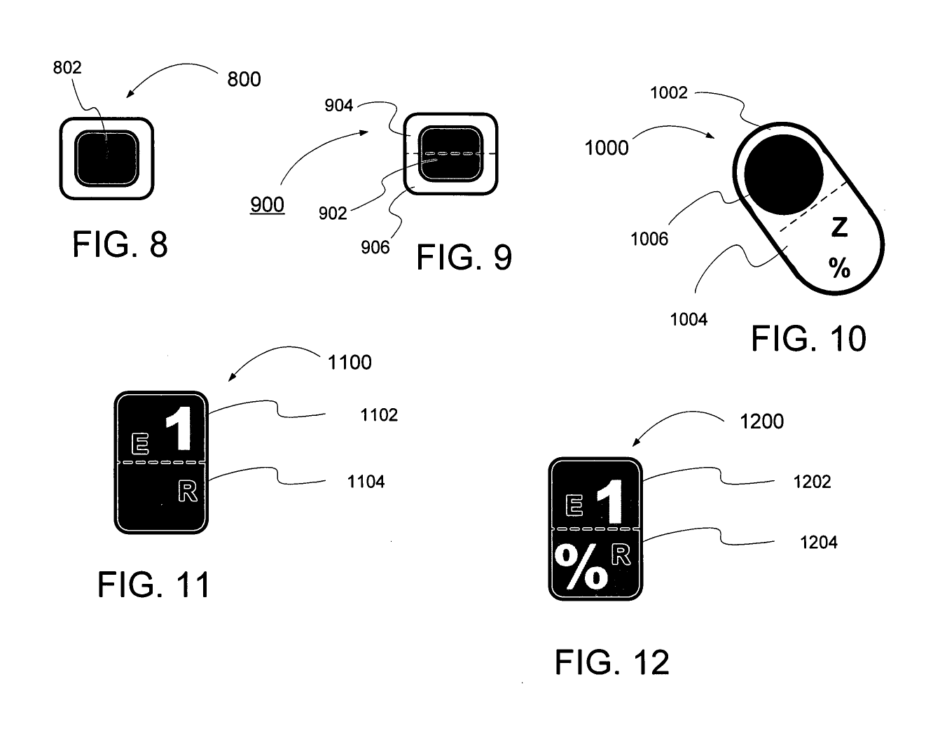

FIG. 8-10 disclose embodiments of mode select keys 800, 900 and 1000 that can be used in conjunction with the embodiments described herein. These keys are understood to operate in conjunction with respective keypads that are not shown in FIGS. 8-10 so as to not unnecessarily obscure the focus of these figures. A comparison of these mode select keys will better illustrate their use in conjunction with various embodiments described herein. FIG. 8 depicts an embodiment of a mode select key 800 for use in conjunction with an embodiment of a keypad having a multi-portion keys. If a keypad associated with mode key 800 is in the first mode, a user can transition the keypad to the second mode by depressing mode key 800. If, while the keypad is in the second mode, a key or key-portion having a second mode character or command is depressed, that second mode character or command will be actuated, and the keypad will return to the first mode.

FIG. 9 depicts an alternative embodiment of a mode select key 900 for use in conjunction with a keypad having multi-portion keys. Within FIG. 9, the dotted line distinguishes first and second key-portions 904, 906 of multi-portion mode select key 900. By depressing the first key-portion 904, the keypad associated therewith is placed in a second mode state, and will remain in that second mode state until the completion of the next keystroke. While in the second mode state, the depression of any key having a second mode character or command will input that character or execute that command. The keystroke will also restore the keypad to the default “first mode” state.

The second key-portion 906 of mode key 900 is a “toggle-on/toggle-off” mode actuator. When key-portion 906 is depressed, the corresponding keypad is placed into a second mode state, and will remain in the second mode state for an indeterminate number of keystrokes. According to an embodiment, the keypad can be restored to the first mode by depressing a key-portion of mode key 900 a second time. Through use of the toggle-on/toggle-off feature, a string of numeric characters, such as a phone number, can be entered without repeated depression of the mode key 900.

FIG. 10 depicts an alternative embodiment of a mode select key 1000 for use in conjunction with a keypad having multi-portion keys. Mode select key 1000 is pictured as having an upper key-portion 1002 with a grayscale emblem acting as a mode shift indicator. The upper key-portion 1002 is configured to shift the mode of a keypad associated therewith. The lower key-portion 1004 has first and second mode characters. If a corresponding keypad is in the first mode, actuation of the lower key-portion 1004 will initialize an input of the character “Z”. If the mode select is activated by key-portion 1002, the corresponding keypad will be placed in the second mode. Depression of the lower key-portion 1004 during the second mode will initialize in input of a percent “%” character. In an embodiment, activation of any key during the second mode will also restore the keypad to the first mode.

FIGS. 11 and 12 are embodiments of multi-portion keys 1100, 1200. These keys are understood to operate in conjunction with respective keypads that are not shown in FIGS. 11 and 12 so as to not unnecessarily obscure the focus of these figures.

FIG. 11 depicts an embodiment of a multi-portion key having first-mode and second mode characters thereon. Alphabetical characters “E” and “R” are displayed on the upper and lower key portions 1102, 1104 of multi-portion key 1100. The alphabetical characters are depicted in a “first mode” font, and the numerical character “1” displayed on the upper key-portion in a “second mode” font. When the keypad corresponding to key 1100 is in the first mode, depression of the upper key-portion 1102 will initialize an input of the character “E.” Alternatively, in the first mode, depression of the lower key-portion ′1104 will initialize an input of the character “R.” When the keypad corresponding to key 1100 is in the second mode, depression of the upper key-portion will initialize an input of the numerical character “1.” An examination of FIG. 11, however, discloses no second mode character displayed on the second key-portion 1104. According to an embodiment, when the keypad corresponding to key 1100 is in the second mode, depression of the second key-portion 1104 will also initiate an input of the numerical character 1.” According to an alternative embodiment, when the keypad corresponding to key 1100 is in the second mode, depression of the second key-portion 1104 will not input any character into the mobile computing device.

FIG. 12 depicts an alternative embodiment of a multi-portion key having first-mode and second mode characters thereon. Alphabetical characters “E” and “R” are displayed on the upper and lower key portions 1102, 1104 of multi-portion key. The alphabetical characters are depicted in a “first mode” font. Character “1” and “%” respectively displayed on the upper and lower key-portions in a “second mode” font. When the keypad corresponding to key 1200 is in the first mode, depression of the upper key-portion 1202 will initialize an input of the character “E.” Alternatively, in the first mode, depression of the lower key-portion 1204 will initialize an input of the character “R.” When the keypad corresponding to key 1200 is in the second mode, depression of the upper key-portion will initialize an input of the numerical character “1.” Alternatively, when in the second mode, depression of the lower key-portion 1204 will initialize an input of the character “%” (percent).

Automatic Mode Selection

In addition to specific mode selection keys as described in FIGS. 8-10, embodiments described contemplate a mode switch from alphabet to numeric input automatically, or at least programmatically, in response to certain functions or events of the device 700. For example, when used in conjunction with a cellular telephone, navigating to, or selecting a field for inputting numerical phone number automatically places the respective keypad into a numerical mode, which, according to the above examples, is the second mode. Referring to FIG. 12, if the mobile computing device associated with key 1200 is in a cell phone mode, in an embodiment, the “%” character input is disabled, and the depression of any key portion 1202, 1204 of key 1200 will initialize a input of the number 1.

A mobile computing device 700 (FIG. 7) can be configured to default to a particular mode for any appropriate application, examples of which are numerical mode default when entering phone numbers in a pre-configured phone-number field, and entering values for calculation in a pre-configured numerical field. In “transparent” mode selection processes as described above, the keypad automatically reverts back to the first mode state when the user exits the screen or field driving the default to the numerical mode.

Predictive Text Variation

FIG. 13 illustrates a multi-portion key implemented on a keypad that is configured for use with predictive text or text selection logic, under an embodiment of the invention. Predictive text applications operate according to software or other programming or logic that associates individual key entries with multiple potential values, and progressively identifies key combinations to suggest as more key entries are added for an entry. As an option or alternative, listed possibilities may be displayed on the fly for the user. For example, in embodiments wherein an alphanumeric key includes the characters 1, A, B, and C, pressing the key entry associated with number “1” in alphabet mode may result in letters “A B C” being displayed for selection. Subsequently, pressing “1” again may result in “BA” and “CA” being displayed, as those two combinations result in formation of common words.

Under a typical past approach, a predictive text keyboard assigns three or four letters to each key entry when an alphabet mode is selected. In a numerical mode, each represents one number. This allows, for example, nine keys to provide most, if not all characters (alphabet and special) for an alphabet mode of the keypad. An example of predictive text software for mobile computing devices is T9 software.

FIG. 13 illustrates an embodiment in which a key pad 1305 is formed on a mobile computing device 1302 from a plurality of multi-portion keys, with each key having two (or more) independently actuatable key portions. Alphanumeric keys 1310 share alphabet and numeric values on different key portions 1312, 1314 respectively. Special character keys 1311 may share alphabet and special character values on different key portions 1315, 1317 respectively. Isolated keys 1313 may have one command or value, and may or may not be segmented or toggled.

An advantage of using predictive text logic in conjunction with a multi-portion key embodiment can be appreciated by understanding the nature of predictive logic. In predictive text applications, when a greater the number of possible alphabetical entries associated with each key, the predictive text algorithm becomes more complex. More key strokes are requires to distil a text entry down to the most likely character combination. In keypads utilizing a three by four key matrix, with some keys devoted to non-alphabetical functions, three, and even four alphabetical characters can be assigned to a single key. By using multi-portion keys described herein, keypad matrices having four rows and five columns, as depicted in FIG. 13, are realizable. In this embodiment, keys need only be assigned one or two alphabetical characters rather than three or more alphabetical characters, thereby increasing the utility of a predictive text keypad.

According to one embodiment, alphanumeric keys 1310 can be individually selected to provide alphabet entries for predictive and/or text selection logic. For example, selection on one key portion 1312 in one key 1310 may result in selection and/or display of the letters “E” and/or “R”. Selection of the other key portion 1314 in the same alphanumeric key 1310 may result in selection of the number “1”. Similarly, selection of one key portion 1317 in the special character key 1311 yields selection and/or display of the letters “Q” and “W”. Selection of the other key portion 1315 in the same special character key 1311 may yield selection of “*”.

In an embodiment such as shown by FIG. 13, key portions 1312, 1314 for key 1310, and key portions 1315, 1317 for key 1311, may be designed according to a multi-portion-key structure such as described by one or more embodiments herein. In one embodiment, each key 1310, 1311 includes a toggle construction (such as described by embodiments of FIG. 3A-#D), but other embodiments may use split-key (FIG. 4A-FIG. 4C) or cushion/deformable key portion designs (FIG. 5A-FIG. 5C).

Furthermore, under one embodiment, the user may have the option of using a mode key 1322 to select an overwrite mode, which in the case provided, is for number alternatives of the alphanumeric keys 1310. When mode key 1322 is selected, either the immediately next, or all (until reselection of mode) subsequent selections of any portion of alphanumeric keys 1310 are recognized as numbers. Thus, for example, when the mobile computing device is used as a phone, each key 1310 provides a bigger viewing area for illustrating numerical values assigned to that key.

### Alternative Embodiments

Many specific details are included herein which are not essential to make or use the embodiments described herein. While embodiments described above illustrate specific applications with alphanumeric (i.e. Roman characters), and known patterns thereof, such as QWERTY arrangements or alphabetical arrangements, the embodiments described herein can be used in conjunction with other linear alphabets, such as Arabic, Greek and Cyrillic, with characters arranged on keypad embodiments described herein according to any known or useful order of characters from their respective alphabets or known keyboard arrangements. Additionally, some software programs for character-based Asian languages, such as Chinese and Japanese, allow complex Asian characters to be entered through key input by an aggregation of component character elements and strokes assigned to different keys on a key input.

Accordingly, the embodiments described herein can be used in conjunction with languages having “non-linear” (character based) alphabets. Throughout the foregoing disclosure and within the appended claims, therefore, reference to keypad arrangements of alphabetical or alphanumeric characters, such as a QWERTY arrangement, comprehends equivalent applications in other linear and non-linear alphabets.

Furthermore, while embodiments described above illustrate a keypad that is integrated to a mobile computing device, one or more embodiments contemplate use of a keypad that is attachable or an accessory to a mobile computing device. Such a keypad may require use of a connector (e.g. Bluetooth, Infrared, Universal Serial Buss (USB) etc.) to communicate actuated signals to a processor of the mobile computing device.

### CONCLUSION

Although illustrative embodiments of the invention have been described in detail herein with reference to the accompanying drawings, it is to be understood that the invention is not limited to those precise embodiments. As such, many modifications and variations will be apparent to practitioners skilled in this art. For example, although examples of many specific embodiments described herein are directed to keypads used in conjunction with small scale mobile computing devices, the scope of the appended claims comprehends keypad embodiments of any size and scale. Accordingly, it is intended that the scope of the invention be defined by the following claims and their equivalents. Furthermore, it is contemplated that a particular feature described either individually or as part of an embodiment can be combined with other individually described features, or parts of other embodiments, even if the other features and embodiments make no mentioned of the particular feature. Thus, the absence of describing combinations should not preclude the inventor from claiming rights to such combinations.

What is claimed is:

1. A keypad for a mobile computing device, the keypad comprising:
a plurality of keys that form at least a portion of the keypad, each key comprising two or more key-portions that share a common footprint, wherein each key-portion is independently insertable, with respect to any other key-portion of that key, for enabling engagement with a corresponding electrical contact.

2. The keypad of claim 1, further comprising a plurality of switches, each switch being oriented beneath a respective key-portion, and wherein an actuation of a key-portion comprises a depression or movement of the key-portion so as to engage its respective switch.

3. The keypad of claim 1, wherein the plurality of keys includes a rocker key having a first key-portion and a second key-portion integrally formed as a contiguous solid member that is pivotable about a pivot member, so as to make effective a first actuation by the first portion pivoting inward or a second actuation by the second portion pivoting inward.

4. The keypad of claim 2, wherein the two or more independently actuatable key-portions of each of the plurality of keys are formed from separate physical members that are configured to move independently from each other in engaging their respective switches.

5. The keypad of claim 1, wherein the plurality of keys includes a first key defining a shape selected from among a group of shapes consisting of a square, a circle, a rectangle, an oval, an ellipse, a polygon, and a racetrack.

6. The keypad of claim 1, wherein each of the plurality of keys defines an elongated symmetrical shape having first and second ends, wherein the first end includes the first key-portion, and the second end includes the second key-portion.

7. The keypad of claim 6, wherein the keypad defines a keypad axis, and wherein the elongated symmetrical shape of a key defines a key axis that is either parallel to the keypad axis or that is intersecting the keypad axis.

8. The keypad of claim 1, wherein the plurality of keys includes alphabetical keys, each alphabetical key displaying from one to two alphabetical characters.

9. The keypad of claim 8, wherein at least some of the alphabetical keys have an alphabetical character display on the first key-portion, and an alphabetical character display on the second key-portion.

10. The keypad of claim 8, wherein the alphabetical keys are organized in a QWERTY key arrangement.

11. The keypad of claim 8, wherein select keys from among the plurality of alphabetical keys further comprise a display of a numerical character.

12. The keypad of claim 1, wherein at least some of the keys are arranged in rows, each row defining a geometric shape selected from among a group of geometric shapes consisting of a line, a curve, an angle, and combinations thereof.

13. A mobile computing device comprising:
a plurality of keys that form at least a portion of the keypad, each key comprising two or more key-portions that share a common footprint, wherein each key-portion is independently actuatable with respect to any other key-portion of that key.

14. The keypad of claim 13, further comprising a plurality of switches, each switch being oriented beneath a respective key-portion, and wherein an actuation of a key-portion comprises a depression or movement of the key-portion so as to engage its respective switch.

15. The mobile computing device of claim 14, further comprising at least one processor configured such that, an engagement of one of the plurality switches initiates a transmission of an electrical signal to the processor.

16. The mobile computing device of claim 13, wherein the plurality of keys includes a rocker key having a first key-portion and a second key-portion integrally formed as a contiguous solid member that is pivotable about a pivot member, wherein an inward pivoting of the first key-portion is configured to initiate a first electrical transmission to the processor, and an inward pivoting of the second key-portion is configured to initiate a second electrical transmission to the processor.

17. The mobile computing device of claim 14, wherein the two or more independently actuatable key-portions of each of the plurality of keys are formed from separate physical members that are configured to move independently from each other when engaging their respective switches.

18. The mobile computing device of claim 13, wherein at least some of the alphabetical keys have an alphabetical character display on the first key-portion, and an alphabetical character display on the second key-portion.

19. The mobile computing device of claim 18, wherein select keys from among the plurality of alphabetical keys further comprise a display of a numerical character.

20. The mobile computing device of claim 19, further comprising a mode key for selecting between an alphabetical character and numerical character on a key from among the select keys.

21. A mobile computing device, the keypad comprising:
a plurality of keys that form at least a portion of the keypad, each key comprising two or more key-portions that share a common footprint, wherein each key-portion is independently actuatable, with respect to any other key-portion of that key, for enabling engagement with a corresponding electrical contact;
a processor that assigns a value to each of the one or more key-portions when that key-portion is actuated, wherein the processor is configured to assign, to each key in a subset of the plurality of keys, two or more alphanumeric characters.

22. The mobile computing device of claim 21, wherein for each key in the subset, the processor is configured to assign an alphabet character for each key-portion when the processor recognizes a first mode, and a number for both key-portions when the processor recognizes a second mode.

23. The mobile computing device of claim 22, wherein the processor recognizes the second mode in response to one or more events selected from a group of events consisting of: (i) selection of a mode key, (ii) receiving an incoming phone call, (iii) operating a telephone application on the mobile computing device, and (iv) entering input into an application field designated as being numeric.

24. The mobile computing device of claim 22, wherein each key in the subset is provided a first marking pattern that is different than a second marking pattern of keys in the plurality of keys that are not in the subset.

25. The mobile computing device of claim 24, wherein all keys in the subset have a common marking pattern that corresponds to a background shading or coloring.

26. The mobile computing device of claim 21, wherein the processor is configured to assign at least two possible alphabet characters to one key-portion of a subset of the plurality of keys, and wherein the one key-portion of the subset of the plurality of keys is usable with predictive text logic.

27. The mobile computing device of claim 21, wherein at least some of the keys in the subset are each provided a numeral assignment for when a numeric mode is recognized by the processor.
